(19) United States
(12) Patent Application Publication
(10) Pub. No.: US 2014/0001728 A1
(43) Pub. Date: Jan. 2, 2014

(54) SENSOR APPARATUS FOR DETERMINING FORCES APPLIED TO A PEDAL OF A BICYCLE

(71) Applicants: Beppo Hilfiker, Muttenz (CH); Joël J. Niederhauser, Liestal (CH); Christopher P. D'Aluisio, Corralitos, CA (US)

(72) Inventors: Beppo Hilfiker, Muttenz (CH); Joël J. Niederhauser, Liestal (CH); Christopher P. D'Aluisio, Corralitos, CA (US)

(73) Assignee: SPECIALIZED BICYCLE COMPONENTS, INC., Morgan Hill, CA (US)

(21) Appl. No.: 13/535,978

(22) Filed: Jun. 28, 2012

(51) Int. Cl. B62M 1/02; G01L 1/14

(52) U.S. Cl. 280/259; 73/862.621; 73/862.626

(57) ABSTRACT

A bicycle including a frame that has a bottom bracket, a first bicycle component, a second bicycle component coupled and responsive to the first bicycle component, and a sensor apparatus coupled to and sandwiched between the first component and the second component. The bicycle also includes a pedal coupled to the crankset and operable to propel the bicycle in response to a force acting on the pedal. The first bicycle component is acted upon by the pedal in response to the force. The sensor apparatus includes a sensor element positioned to sense a force transferred from the first component to the second component and indicative of the force acting on the pedal.

### BACKGROUND

The present invention relates to bicycles, and more particularly to a bicycle including a sensor apparatus for measuring forces applied to the pedals of the bicycle.

Typically, bicycles are propelled by pedals mounted to a crankset at opposite ends of a spindle. A typical crankset is equipped with two cranks that each supports a pedal at one end and couples with a spindle adjacent the other end. These cranksets transfer energy exerted on the pedals by a rider to forward motion of the bicycle. The crankset typically includes one or more sprockets that engage a chain to transfer the rotary motion of the crankset to a rear wheel.

Often, it is desirable to know the directional forces applied to the pedals by a rider so that the power associated with the rider can be accurately determined. Some existing bicycles include power meters located at the rear hub of the bicycle. Other systems determine the power of the rider using sensors that are inserted into the pedal or the crank arm. Such systems typically require custom-made components to accommodate the power meters.

### SUMMARY

In one construction, the present invention provides a bicycle including a frame that has a bottom bracket, a first bicycle component, a second bicycle component coupled and responsive to the first bicycle component, and a sensor apparatus coupled to and sandwiched between the first component and the second component. The bicycle also includes a pedal coupled to the crankset and operable to propel the bicycle in response to a force acting on the pedal. The first bicycle component is acted upon by the pedal in response to the force. The sensor apparatus includes a sensor element positioned to sense a force transferred from the first component to the second component and indicative of the force acting on the pedal.

In another construction, the present invention provides sensor apparatus for determining a force applied to a pedal of a bicycle. The sensor apparatus includes a housing that has first and second opposing walls, a first sensor element coupled to the first wall, and a second sensor element coupled to the second wall and movable relative to the first sensor element. A detector is in communication with the first sensor element and the second sensor element to detect a change in distance between the first and second sensor elements indicative of the force applied to the pedal.

In another construction, the present invention provides a bicycle including a frame that has a bottom bracket, a crankset attached to the bottom bracket and including a crank arm and a spider operatively coupled to the crank arm, and a pedal coupled to the crank arm. The pedal is operable to rotate the spider and propel the bicycle. The bicycle also includes sensor apparatus disposed in the spider and positioned to sense a force acting on the pedal.

Other aspects of the invention will become apparent by consideration of the detailed description and accompanying drawings.

### BRIEF DESCRIPTION OF THE DRAWINGS

FIG. 1 is a side view of a bicycle including a crankset and sensor apparatus embodying the present invention.

FIG. 2 is a perspective view of a crank arm of the crankset, the sensor apparatus, and a pedal.

FIG. 3 is an exploded view of the assembly of FIG. 2.

FIG. 4 is an enlarged view of a portion of the assembly of FIG. 3.

FIG. 5 is a side view illustrating the crank arm, the sensor apparatus, and the pedal in three rotational positions and associated vector forces applied to the pedal.

FIG. 6 is a section view of the crank arm, the sensor apparatus, and the pedal taken along line 6-6 in FIG. 2.

FIG. 7 is a section view similar to FIG. 6 illustrating the crank arm, the sensor apparatus, and the pedal when pressure is applied to the pedal by a rider.

FIG. 8 is a section view of the crank arm, the sensor apparatus, and the pedal taken along line 8-8 in FIG. 2.

FIG. 9 is a schematic view illustrating a portion of an electrical circuit of the sensor apparatus.

FIG. 10 is an enlarged section view of another housing for the sensor apparatus of FIG. 2.

FIG. 11 is a section view of a housing for another sensor apparatus embodying the invention.

FIG. 12 is a section view of the sensor apparatus of FIG. 11 illustrating a force acting on the housing.

FIG. 13 is a perspective view of the sensor apparatus of FIG. 11 coupled to a spider of the bicycle of FIG. 1.

FIG. 14 is an exploded perspective view of the sensor apparatus and the spider of FIG. 13.

FIG. 15 is a perspective view of a portion of the spider of FIG. 13.

FIG. 16 is a section view of the spider and the sensor apparatus of FIG. 13.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

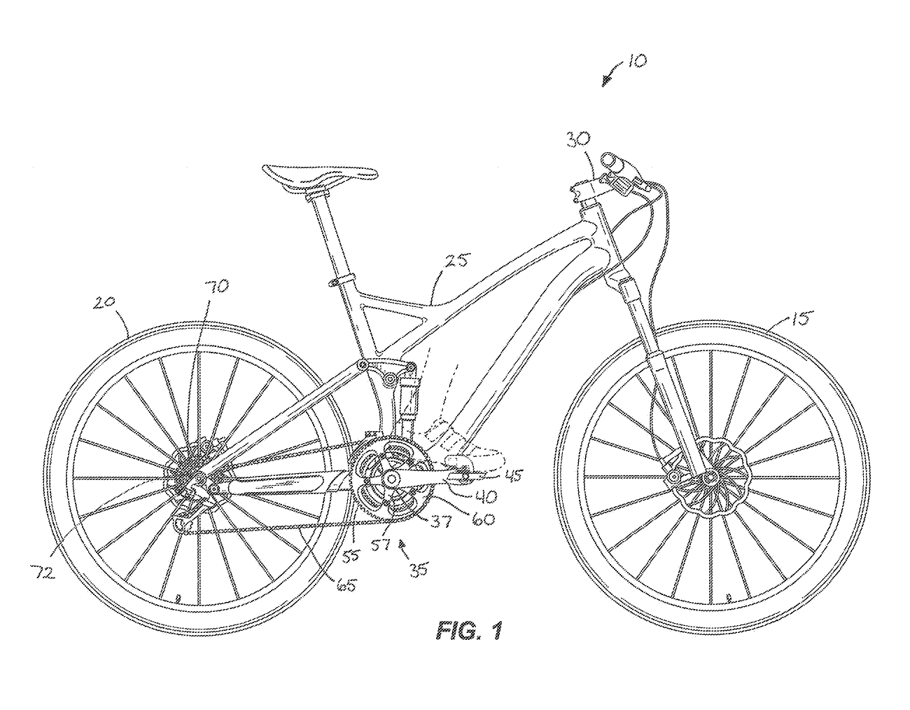

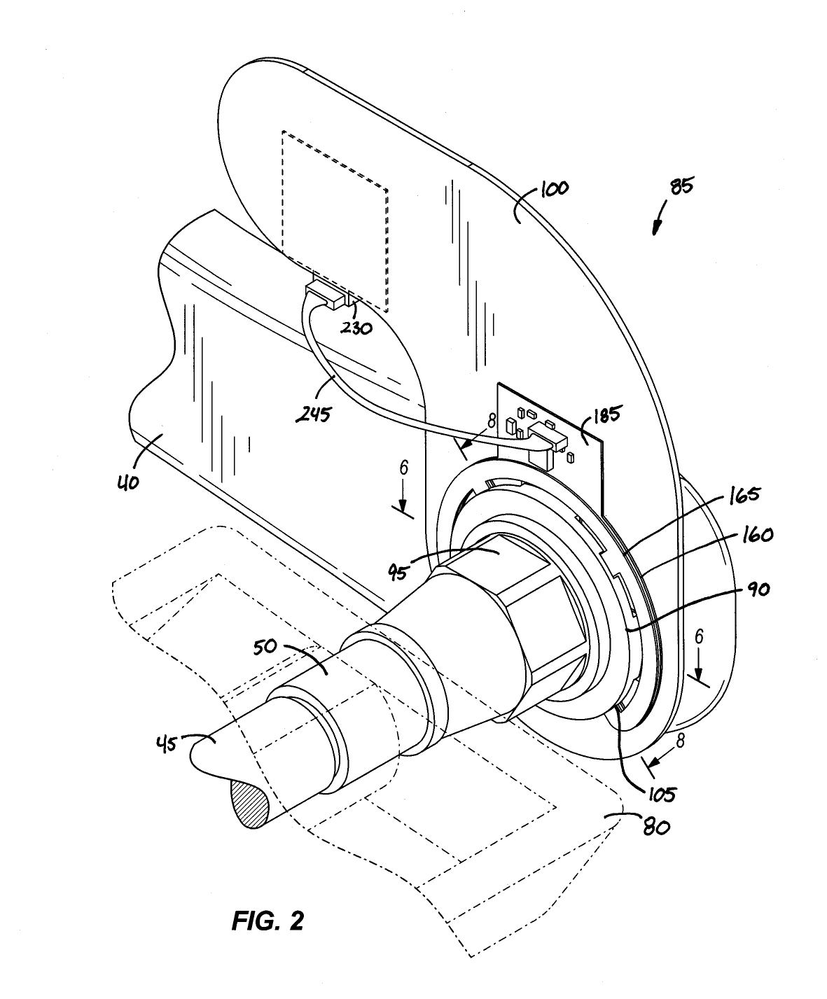

FIG. 1 illustrates a bicycle 10 that includes a front wheel 15, a rear wheel 20, a frame 25, a steering assembly 30, and a crankset 35 attached to a bottom bracket 37 of the frame 25. With reference to FIGS. 1 and 2, the crankset 35 includes opposed crank arms 40 (one shown) and pedals 45 (one shown) that are attached to distal ends of the crank arms 40 via pedal spindles 50 to allow a rider to rotate the crankset 35 and to propel the bicycle 10, as is known in the art. A front sprocket assembly 55 is coupled to the crankset 35 by a spider 57 (FIGS. 1 and 13) and may include one or more chain rings 60 that couple to a chain 65. The chain 65 engages the rear wheel 20 through a series of rear sprockets 70 connected to a rear hub 72.

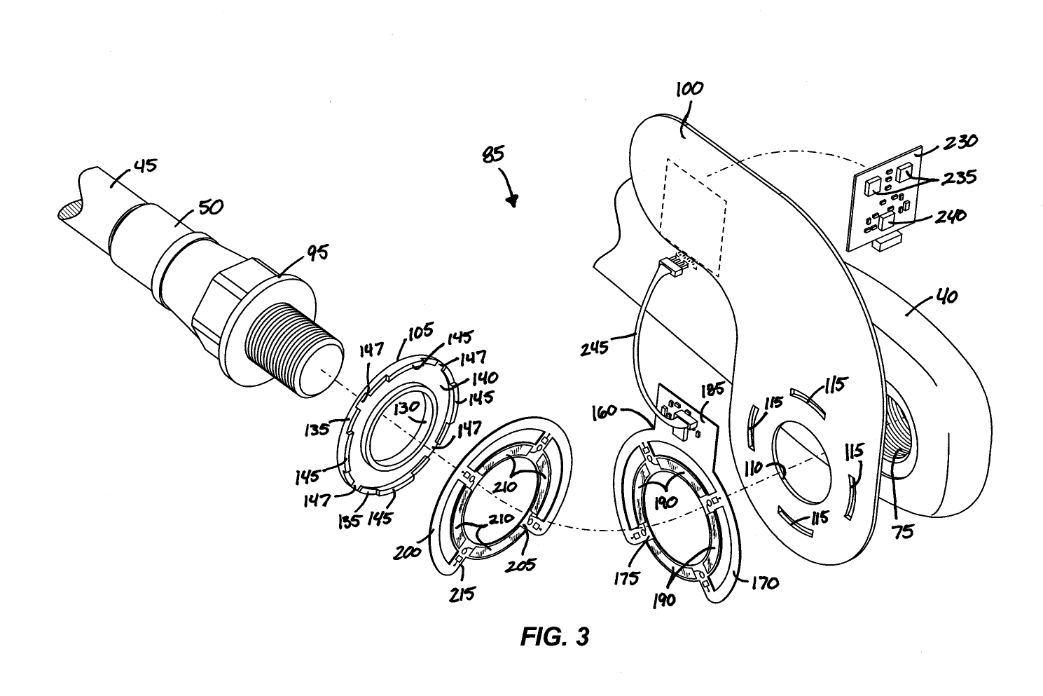

FIGS. 2 and 3 show that each pedal spindle 50 has a shaft that is inserted (e.g., threaded) into a hole 75 in the distal end of the crank arm 40. The pedal 45 includes a cage 80 (e.g., for a clipless pedal 45) that rotates about the pedal spindle 50 so that pedal 45 can move with the rider's foot.

FIGS. 2, 3, and 5-8 illustrate a sensor apparatus or capsule 85 positioned between the crank arm 40 and the pedal 45 (e.g., around the shaft of the pedal spindle 50) to determine the directional (i.e., vector) forces and the corresponding power applied by the rider to the pedal 45. While the sensor apparatus 85 is described below with regard to a capacitive sensor, other sensors (e.g., a piezo sensor, an optical sensor, a pressure sensor, a strain gauge sensor such as a wavy plate strain sensor, etc.) can be placed between the crank arm 40 and the pedal 45 to determine the directional forces applied to the pedal 45.

In particular, the sensor apparatus 85 is received on an end of the pedal spindle 50 and includes a housing 90 that is located axially along the pedal spindle 50 between the crank arm 40 and a fastener head or flange 95 of the pedal spindle 50 that is proximate the crank arm 40. Stated another way, the sensor apparatus 85 is sandwiched between the crank arm 40 and the flange 95 (e.g., abutting the crank arm 40 and the flange 95) so that the sensor apparatus 85 is held in engagement with the crank arm 40 when the pedal spindle 50 is inserted and tightened on the crank arm 40 via the flange 95. As illustrated, a washer 97 is disposed in a recess 98 of the crank arm 40 and surrounds the pedal spindle 50.

With reference to FIGS. 2, 3, 6, and 7, the illustrated housing 90 includes a back plate 100 that abuts the crank arm 40 and a shell 105 that is coupled to the back plate 100 and that abuts the pedal spindle 50. The back plate 100 is a flat plate that holds the washer 97 in the recess 98 of the crank arm 40, and that defines a first side or wall of the housing 90. The back plate 100 is attached (e.g., adhered, formed integrally with, etc.) to the crank arm 40 to provide a rigid mounting surface for the shell 105. As illustrated, the back plate 100 is elbow shaped, and has a first hole 110 for allowing passage of the pedal spindle, and circumferentially-spaced apertures 115 surrounding the first hole 110. As will be appreciated, the back plate 100 can have other shapes and can be integrally formed with the crank arm 40.

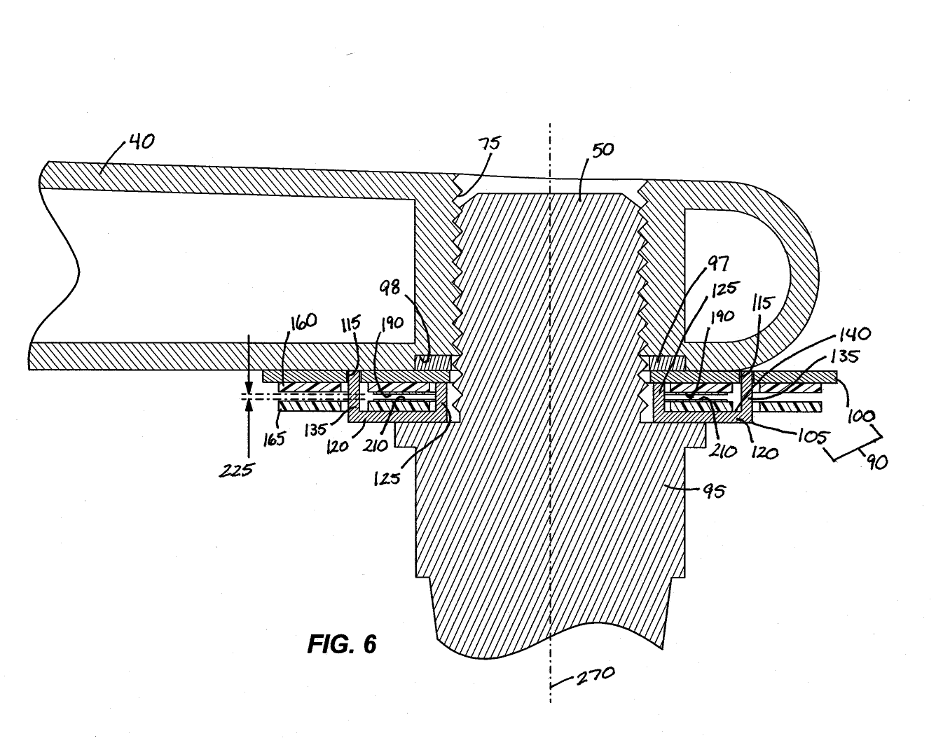

The illustrated shell 105 is defined by an open-ended doughnut-shaped structure that has an outer wall 120, an inner radial wall 125 extending from the outer wall 120 and defining a second hole 130, and an outer radial wall 135 extending from the outer wall 120. The outer radial wall 135 is spaced from the inner radial wall 125 to form a hollow area or trough 140. With reference to FIGS. 3 and 6, the outer radial wall 135 defines tabs 145 that extend farther from the outer wall 120 than the most distal part of the inner radial wall 125. The tabs 145 align and couple to the back plate 100 within the apertures 115 so that the trough 140 is fully or substantially enclosed by the remaining portions of the outer radial wall 135, and so that the outer wall 120 does not move relative to the back plate 100. With the exception of small recesses 147, which are further explained below, the portions of the outer radial wall 135 between the tabs 145 abut the back plate 100 when the shell 105 is attached to the back plate 100.

FIG. 10 illustrates an alternative housing 150 for the sensor apparatus 85. The only difference between the housing 90 described with regard to FIGS. 2, 3, 5, 6, and 7 and the housing 150 illustrated in FIG. 10 is that the shell 105 of the housing 150 has an annular rib 155 on the inside of the outer radial wall 135 that forms a shelf. The shelf engages or abuts the back plate 100 continuously around the shell 105 to provide additional rigidity to the shell 105 relative to the back plate 100.

With reference to FIGS. 2-4, 6, and 7, the sensor apparatus 85 also includes a first sensor element 160 in the form of a first substrate (e.g., a printed circuit board), and a second sensor element 165 in the form of a second substrate (e.g., a printed circuit board). The first sensor element 160 is mounted to the crank arm 40 via the back plate 100 (e.g., adhered to the back plate 100). FIGS. 3 and 4 show that the first sensor element 160 is defined by a first radial arm 170 and a first concentric platform 175 that is connected to the radial arm by first bridges 180. The first radial arm 170 has an enlarged area that supports a first detector or sensor board 185.

As shown in FIGS. 3 and 4, the first platform 175 supports first sensors 190 that are circumferentially spaced from each other and that are in electrical communication with the sensor board 185 via electrical contact points 195 on the first bridges 180. The first bridges 180 are relatively small compared with the size of the first sensors 190 to maximize the sensing capacity of the first sensor element 160. As illustrated, the first sensor element 160 includes four circumferentially-spaced sensors and four corresponding bridges and contact points 195, although fewer or more than four sensors and corresponding bridges and contact points 195 are possible and considered herein. The sensors 190 are in electrical communication with the contact points 195 via circuit board material that is printed on the first sensor element 160.

Referring to FIGS. 3, 4, 6, and 7, the second sensor element 165 is mounted (e.g., adhered) to the outer wall 120 of the shell 105 within the trough 140 so that the second sensor element 165 is positioned adjacent the pedal 45. FIGS. 3 and 4 show that the second sensor element 165 is defined by a second radial arm 200 and a second concentric platform 205 that is connected to the first radial arm 170 by second bridges 215. With the exception of the sensor board 185 on the first sensor element 160, the first sensor element 160 and the second sensor element 165 are a mirror image of each other. In particular, the second sensor element 165 has a substantially circular cross-sectional shape that includes four circumferentially-spaced second sensors 210. The second sensors 210 are in electrical communication with the sensor board 185 via respective electrical contact points 220 on the second bridges 215. More specifically, the sensors 210 are in electrical communication with the contact points 220 via circuit board material that is printed on the second sensor element 165. With reference to FIGS. 4 and 8, the contact points 220 of the second sensor element 165 are soldered to the contact points 195 of the first sensor element 160 so that signals from the second sensors 210 can be transmitted to the first sensor board 185 through the circuit board material of the first sensor element 160.

With reference to FIG. 6, when the sensor apparatus 85 is assembled, the second sensor element 165 is spaced apart from the first sensor element 160 to define a relatively small gap 225 (e.g., 0.1 mm-0.3 mm). The gap 225 can be filled with any suitable compressible medium (e.g., gas such as air, a resin, a thin strip of material such as tape, etc.). In addition, the second sensors 210 are aligned with and face the first sensors 190. The first and second sensors 190, 210 are complementary to each other and determine the size of the gap 225, or conversely, the thickness of the compressible medium. The illustrated first and second sensors 190, 210 are capacitor plates that cooperatively determine the gap size (or the thickness of the compressible medium), although other sensors (e.g., piezo sensors, pressure sensors, strain gauge sensors, etc.) are possible.

With continued reference to FIGS. 2-4, the sensor apparatus 85 further includes a second detector or sensor board 230 that is located remotely from the first sensor board 185. As illustrated, the second sensor board 230 is attached to the back plate 100 (e.g., on the opposite side). However, the second sensor board 230 can be attached to the crank arm 40 in any suitable location. The second sensor board 230 includes an accelerometer 235 for determining the magnitude and direction of acceleration of the pedal 45, and a transmitter 240 that can communicate with a remote device (e.g., display, data logger, battery, etc.). The second sensor board 230 is electrically connected to the first sensor board 185 via a wire 245, although other connections (e.g., wireless) are possible.

The sensor apparatus 85 is assembled by attaching the first sensor element 160 to the back plate 100 and attaching the second sensor element 165 to the shell 105. The shell 105 is then attached to the back plate 100 by engagement of the tabs 145 with the apertures 115. As will be appreciated, the back plate 100 and shell 105 can be permanently joined together (e.g., welded, adhered, etc.) after the first and second sensor elements 160, 165 are put in place. In the assembled state, the bridges 180, 215 extend through the outer radial wall 135 through the recesses 147 to provide communication from within the housing 90 to the sensor board 185. The assembled sensor apparatus 85 is coupled to the bicycle 10 by inserting the pedal spindle 50 through the first and second holes 110, 130 of the housing 90, and then attaching (e.g., threading) the pedal spindle 50 to the crank arm 40.

The pedal spindle 50 is attached to the crank arm 40 with a predetermined amount of force (e.g., 28, N-m). In this manner, the amount of pre-stress on the sensor apparatus 85 is known. Knowing the pre-stress, the sensor apparatus 85 has a baseline measurement for the size of the gap 225 (or material thickness) so that a change relative to the baseline measurement can be determined. Generally, the sensor apparatus 85 determines the vector forces applied to the pedal 45 when the rider engages the pedal 45 to move the bicycle 10 forward as well as the tangential velocity of the pedal 45, which is determined using the accelerometer 235. In particular, the sensor apparatus 85 determines the tangential force and the radial force applied to the pedal 45 and determines the overall power of the rider based on the amount and direction of the forces and the tangential pedal velocity.

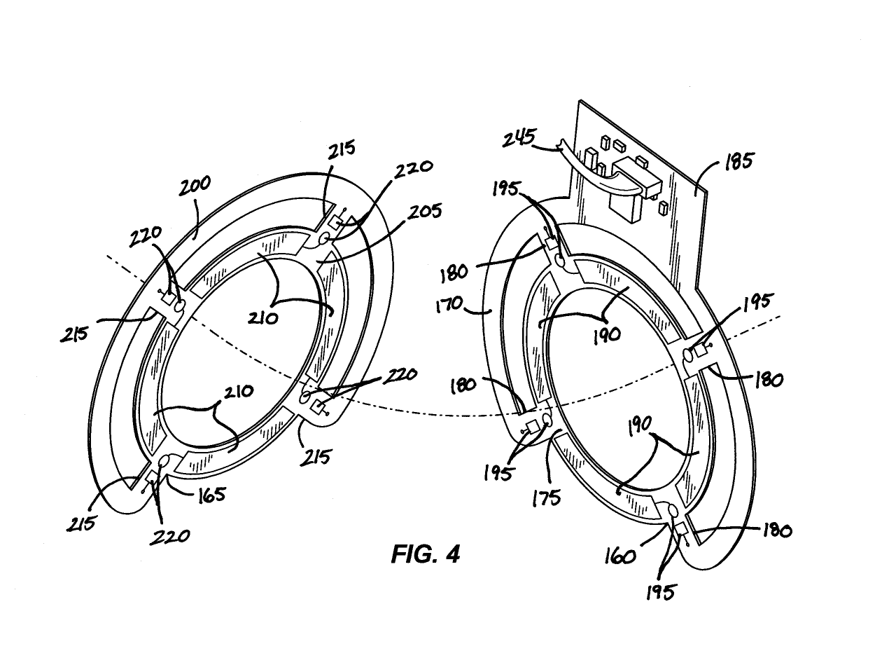

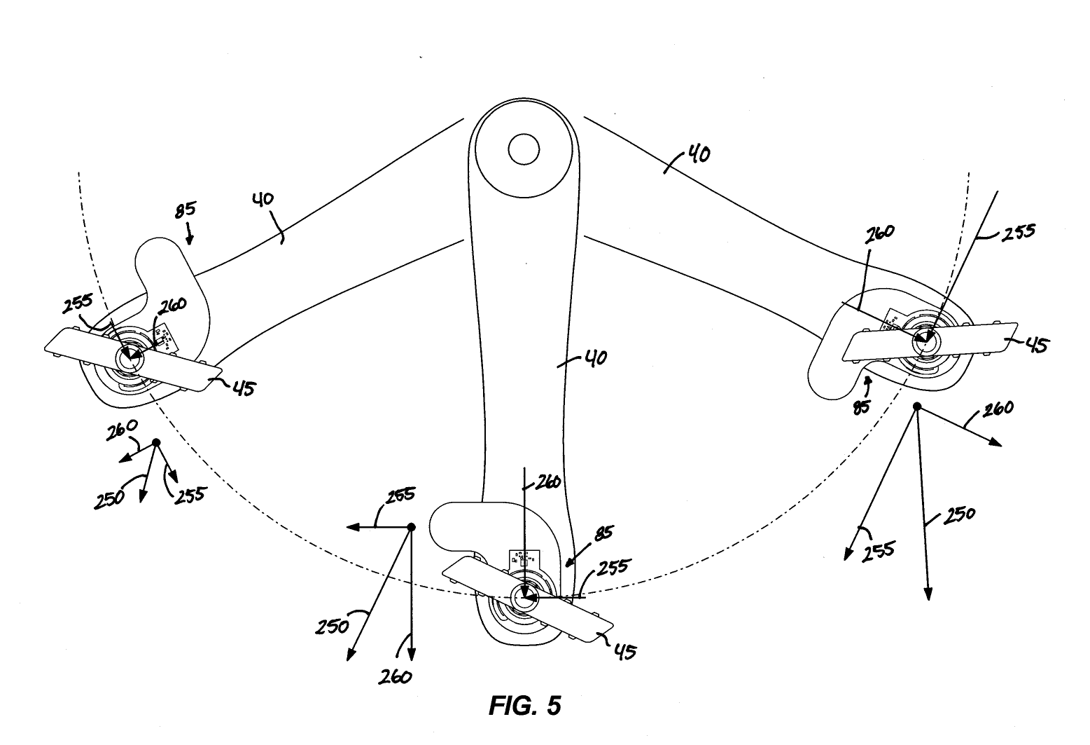

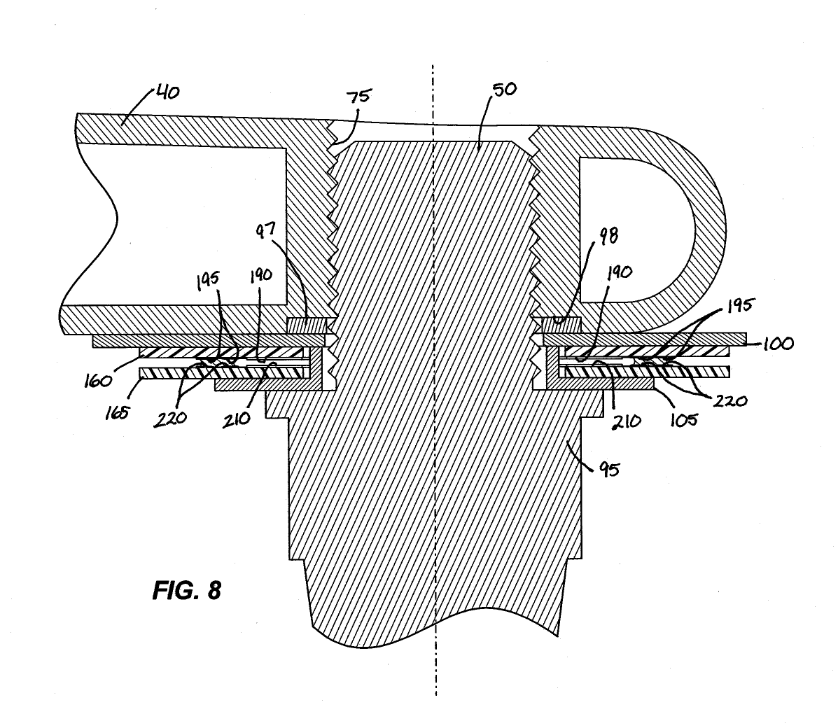

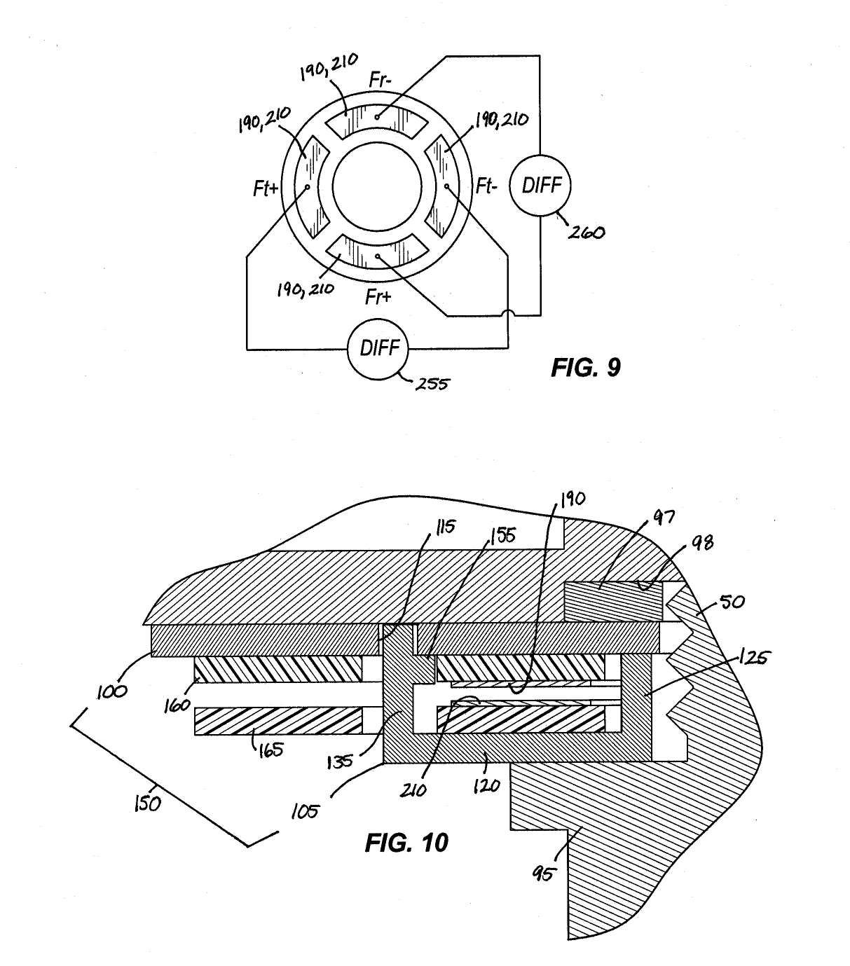

Referring to FIGS. 5-9, when a rider pushes or pulls on the pedal 45 (depending on the radial orientation of the pedal 45 relative to the bicycle 10), the force vector 250 associated with the rider's engagement of the pedal 45 has a useful tangential force vector 255 along the arcuate path of the pedal 45 and a radial force vector 260 (unusable or wasted force) in a direction along the crank arm 40. The amount of tangential and radial force vectors 255, 260 are determined by the sensor apparatus 85 based on a change in size of the gap 225 between pairs of opposing sensors 190, 210.

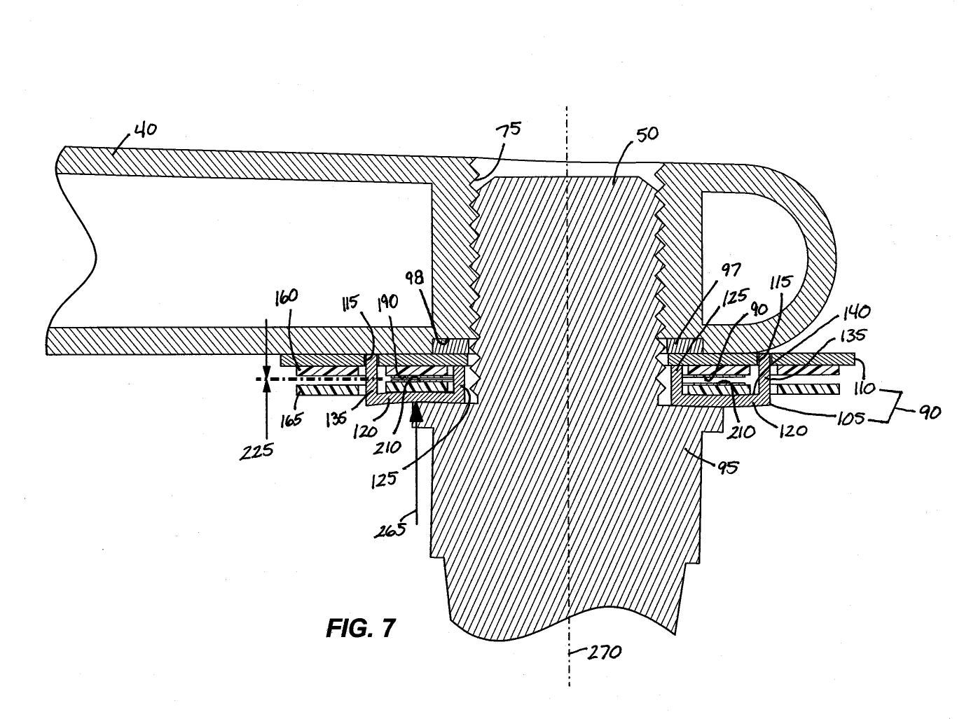

When pressure is applied to the pedal 45, the resulting force is transferred from the pedal spindle 50 to the crank arm 40 by the shaft. As shown in FIG. 7, the force (indicated by arrow 265) deflects the pedal spindle 50 a small amount, which in turn deforms the outer wall 120 of the shell 105. For comparison, FIG. 6 shows the pedal 45 without pressure from the rider (a non-deformed state). Generally, a substantial portion of the force acting on the pedal 45 is transferred directly through the pedal spindle 50 to the crank arm 40. Only a small portion of the force acts on the sensor apparatus 85. Stated another way, the pedal spindle 50 is directly acted upon by the pedal 45 in response to pressure applied to the pedal 45, and transfers most of the force directly to the crank arm 40.

Deflection of the pedal spindle 50 (e.g., generally longitudinally inward along the crank arm 40 as shown in FIG. 7) causes a portion of the outer shell 105 and the second sensor element 165 (the left side of the housing 90 in FIG. 7) to move toward the first sensor element 160 a small amount in a direction parallel to a pedal axis 270, while also causing the opposed portion of the outer shell 105 and the second sensor element 165 (the right side of the housing 90 in FIG. 7) to move away from the first sensor element 160 a small amount in the opposite direction. The change in the gap 225 on both sides of the housing 90 is detected by the sensor apparatus 85, and the difference is used to determine the corresponding tangential and radial forces 255, 260 being applied to the pedal 45.

In particular, the sensor board 185 senses the force transferred from the pedal spindle 50 to the crank arm 40 via detecting the change in distance or change in volume between the first sensor element 160 and the second sensor element 165 using all four sensors 190. The sensor board 185 determines the amount of the directional forces 255, 260 that are being applied to the pedal 45 based on the change in distance or change in volume. With reference to FIG. 8, two opposed sensors 190, 210 of the first and second sensor elements 160, 165 cooperatively determine the tangential force 255 and the remaining two opposed sensors 190, 210 of the first and second sensor elements 160, 165 determine the radial force 260 based on the change in size of the gap 225 between the respective sensors 190, 210. These directional forces 255, 260 are then communicated to the second sensor board 230, which determines the tangential velocity of the pedal 45 and the corresponding power of the rider in part using the accelerometer 235. This information can then transferred to the remote device (not shown).

The sensor apparatus 85 provides a separate sensor component that can be used universally with existing crank arms 40 and pedals 45 without much, if any, modification of the crank arms 40 and the pedals 45. The sensor apparatus 85 can be attached to one or both sides of the bicycle 10 so that the directional forces associated with pressure on the pedal 45 can be determined for the rider's left and/or right leg.

By sandwiching the sensor apparatus 85 between the crank arm 40 and the pedal 45, accurate measurements can be taken of the directional forces 255, 260 and acceleration (i.e., the position and tangential velocity of the pedal 45) resulting from pressure applied to the pedal 45 so that the power of the rider can be determined. Furthermore, the sensor apparatus 85 is located so that force applied to the pedal 45 directly acts on the sensor elements 160, 165. As a result, separate (i.e., independent) and accurate measurements of the power generated by the rider's left and right legs can provide valuable data that can be used to evaluate and improve the rider's ability.

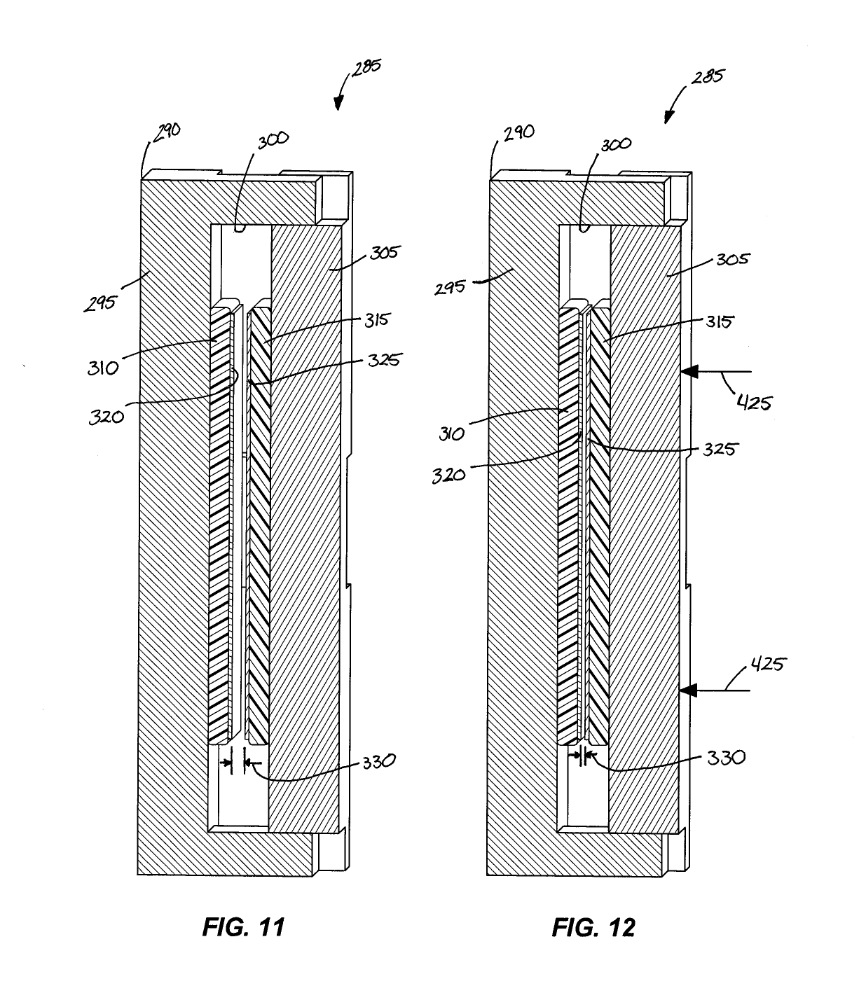

FIGS. 11 and 12 illustrate another sensor apparatus or capsule 285 that can be positioned on the bicycle 10 in lieu of or in addition to the sensor apparatus 85 to determine the force applied by the rider to the pedal 45. For example, the sensor apparatus 285 can be located in the spider 57 (see FIG. 13), although the sensor apparatus 285 can be positioned in other locations (e.g., the bottom bracket 37, the rear hub 72, etc.). Except as described below, the sensor apparatus 285 is the same as the sensor apparatus 85 described with regard to FIGS. 2-10.

The illustrated sensor apparatus 285 includes a housing 290 that has a cup-like back plate or shell 295 defining a hollow area or trough 300, and a cap plate 305 engaged with the back plate 295 (e.g., via flexible material so that the cap plate 305 can move relative to the shell 295) to enclose the trough 300. Alternatively, either or both the back plate 295 and the cap plate 305 can be cup-like in shape. Generally, the structure of the housing 290 can vary based on where the sensor apparatus 285 is located on the bicycle 10. Also, the shape of the housing 290 can be modified to fit the location on the bicycle 10.

With continued reference to FIGS. 11 and 12, the sensor apparatus 285 also includes a first sensor element 310 in the form of a first substrate (e.g., a printed circuit board), and a second sensor element 315 in the form of a second substrate (e.g., a printed circuit board). The illustrated first sensor element 310 and the second sensor element 315 are a mirror image of each other. The first sensor element 310 is mounted to (e.g., adhered to) the back plate 295 and supports a first sensor 320. The second sensor element 315 is mounted to (e.g., adhered to) the cap plate 305 and supports a second sensor 325. The sensors 320, 325 are in electrical communication with a sensor or detector board (not shown) via circuit board material printed on the first and second sensor elements 310, 315. Unlike the sensor apparatus 85, the sensor apparatus 285 has only one first sensor 320 and one second sensor 325. Stated another way, the sensor apparatus 285 incorporates only one quadrant of the sensor apparatus 85 into the housing 290.

The sensor apparatus 285 is assembled by attaching the first sensor element 310 to the back plate 295 and attaching the second sensor element 315 to the cap plate 305. The cap plate 305 is then attached to the back plate 295. The assembled sensor apparatus 285 is then coupled to the bicycle 10.

When the sensor apparatus 285 is assembled, the second sensor element 315 is spaced apart from the first sensor element 310 to define a relatively small gap 330 (e.g., 0.1 mm-0.3 mm) that can be filled with any suitable compressible medium (e.g., gas such as air, a resin, a thin strip of material such as tape, etc.). Also, the second sensor 325 is aligned with and faces the first sensor 320. The first and second sensors 320, 325 (e.g., capacitive sensors, strain gauges, piezo sensors, pressure sensors) are complementary to each other and determine the size of the gap 330, or conversely, the thickness of the compressible medium.

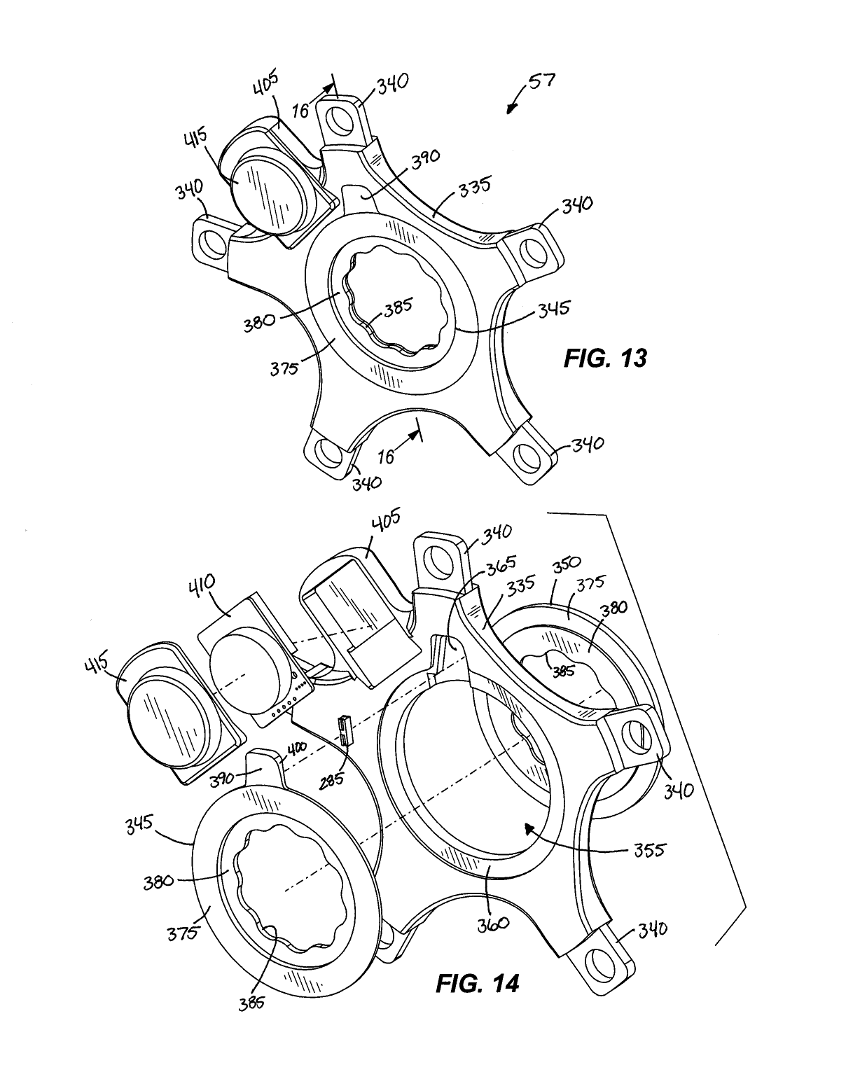

FIGS. 13-16 show that the sensor apparatus 285 (one shown) is disposed in the spider 57 to detect the force applied by the rider to the pedals 45. With reference to FIGS. 13 and 14, the spider 57 has a central body or central portion 335, arms 340 radially extending outward from the central portion 335, a first insert 345 coupled to the central portion 335, and a second insert 350 coupled to the central portion opposite the first insert 345. The arms 340 attach the front sprocket assembly 55 to the central portion 335.

The central portion 335 has a hollow 355 located at the center of the spider 57. On both sides (one shown) of the spider 57, the central portion 335 has a recessed inner periphery 360 that surround the hollow 355. As shown in FIGS. 14 and 16, the central portion 335 also has a cavity 365 that is radially offset from the center of the spider 57 and that is located radially in-line with and extending partially along one arm 340. The cavity 365 is in communication with the hollow 355 and extends deeper into the side of the spider 57 than the recessed inner periphery 360. With reference to FIG. 16, the shell 295 of the sensor apparatus 285 is attached to a sidewall 370 that partially defines the cavity 365. Although the illustrated spider 57 has one sensor apparatus 285 positioned in the cavity 365, the spider 57 can include several sensor apparatuses 285 (e.g., one for each arm 340).

With reference to FIGS. 13-16, each of the first insert 345 and the second insert 350 has a rim 375 coupled to the spider 57 and a spindle portion 380 extending radially inward from and around the rim 375. Each rim 375 is engaged with the central portion 335 within the respective recessed inner periphery 360 so that the inserts 345, 350 are nested in the spider 57. The spindle portions 380 partially overlap or cover the hollow 355 and have respective apertures 385 that is sized and shaped to fit onto a spindle (not shown) of the crankset 35.

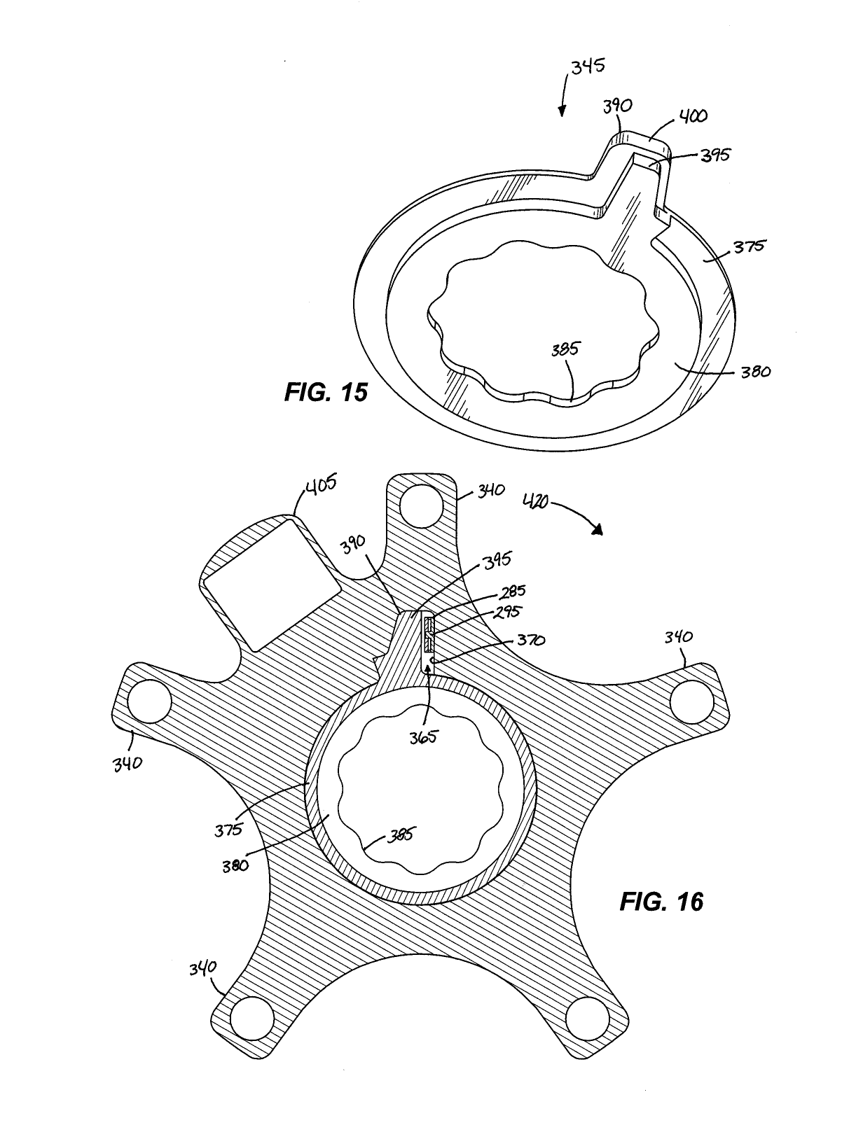

FIGS. 13-16 show that the first insert 345 also has a spider engagement 390 extending radially outward from the rim 375 and recessed in the spider 57. As illustrated, the spider engagement 390 has a first portion 395 that is disposed in the cavity 365, and a second portion 400 that overlays the cavity 365 to cover the sensor apparatus 285. As shown in FIGS. 15 and 16, the first portion 395 is shaped to generally conform to the shape of the cavity 365 and is sized to be smaller than the cavity 365 to accommodate the sensor apparatus 285. The sensor apparatus 285 is positioned between the central portion 335 and the spider engagement 390 so that the first and second sensor elements are responsive to a force transferred from the first insert 345 to the central portion 335 to detect the vector force acting on the pedal. In other words, the spider engagement 390 is operatively coupled to the central portion 335 through the sensor apparatus 285 to transfer a force from the crank arm 40 to the spider 57 (i.e., between the first insert 345 and the central portion 335). In some constructions, the first sensor element 310 can be directly coupled to the spider engagement 390 and the second sensor element 315 can be coupled to a wall of the cavity 365 without the housing 290 to determine the force transferred between the crank arm 40 and the spider 57.

The first insert 345 is rotatable relative to the central portion 335 so that the sensor apparatus 285 can detect the force being transferred from the crank arm 40 to the spider 57. As illustrated, the first portion 395 is spaced a small distance (e.g., less than 1 mm) from the sensor apparatus 285 absent a force on the pedal 45, although the first portion 295 can rest against the sensor apparatus 285. As shown in FIGS. 13-15, the second portion 400 is sized to completely enclose the cavity 365.

With continued reference to FIGS. 13 and 14 and 16, the spider 57 also includes a housing 405 that is attached to the central portion 335 between two arms 340. An electronic module 410 is disposed in the housing 405 and is enclosed by a cover 415. The electronic module 410 is in communication with the sensor apparatus 285 (e.g., by wired or wireless connection) to detect the change in the gap 330 between the first sensor element 310 and the second sensor element 315 and thus determine the force being applied to the pedal 45 by the rider. As shown, the electronic module 410 is located adjacent the sensor apparatus 285 and has a power source (e.g., a battery) to provide power for the sensor apparatus 285 and for communicating data to a remote location (e.g., a computer mounted on the bicycle 10).

The sensor apparatus 285 determines the absolute force 250 that is applied to the pedal 45 when the rider engages the pedal 45 to move the bicycle 10 forward. As discussed with regard to FIG. 5, when the rider pushes or pulls on the pedal 45 (depending on the radial orientation of the pedal 45 relative to the bicycle 10), the force vector 250 associated with the rider's engagement of the pedal 45 has a useful tangential force vector 255 along the arcuate path of the pedal 45 and a radial force vector 260 (unusable or wasted force) in a direction along the crank arm 40. Because the sensor apparatus 285 only has one each of the first sensor 320 and the second sensor 325 (i.e., the sensor apparatus 285 does not have multiple quadrants of sensors) only the magnitude of the force vector 250 is determined by the sensor apparatus 285 based on a change in size of the gap 330 between the opposing sensors 320, 325.

The first insert 345 is coupled to the central portion 335 so that the insert 345 can move (i.e., rotate) a small amount relative to the spider 57. The inserts 345, 350 are positioned between the bottom bracket 37 and the crank arm 40 so that the inserts 345, 350 are held in lateral engagement with the spider 57. FIG. 11 shows the sensor apparatus 285 in a non-deformed state (e.g., when no force is applied to the pedal 45). With reference to FIGS. 12 and 16, the first portion 395 of the engagement member 390 engages and acts upon the sensor apparatus 285 when a force is applied to the pedal 45 to cause rotation of the spider 57 (in the direction indicated by arrow 420 in FIG. 16) and thus the sprocket assembly 55. Generally, a substantial portion of the force transferred from the pedal 45 to the spider 57 is transferred directly through the sensor apparatus 285. Stated another way, the first insert 345 is indirectly acted upon by the pedal 45 (i.e., via the pedal spindle 50 and the crank arm 40) in response to pressure applied to the pedal 45, and transfers most, if not all, of the force directly to the central portion 335 through the sensor apparatus 285.

In particular, the engagement member 390 rotates into engagement with the sensor apparatus 285, and the force (indicated by arrow 425 in FIG. 12) of the first portion 395 acting on the sensor apparatus 285 deforms the cap plate 305 (i.e., moves at least a portion of the cap plate 305 relative to the shell 295) and rotates the spider 57. Deformation of the cap plate 205 moves the second sensor element 315 toward the first sensor element 310 a small amount, and the resulting change in the size of the gap 330 is detected by the sensor apparatus 285 and is used to determine the corresponding vector force 250 being applied to the pedal 45. Generally, the size of the gap 330 will vary depending on the magnitude of the force acting on the sensor apparatus 285. When the force acting on the pedal 45 is removed, the sensor apparatus 285 returns to the non-deformed state.

Placement of the sensor apparatus 85 between the crank arm 40 and the pedal spindle 50, which is acted upon directly by the pedal 45, provides accurate measurements of the resultant force vector 250 stemming from the force applied to the pedal 45. The sensor apparatus 285, in some contexts, is a simplified version of the sensor apparatus 85. Placement of the sensor apparatus 285 remote from the pedals 45 (e.g., in the bottom bracket 37, the spider 57, the rear hub 72, or in other locations on the bicycle 10), where the corresponding bicycle component (e.g., insert 345) is acted upon indirectly by the pedal 45, also provides accurate measurements of the resultant force vector 250 stemming from the force applied to the pedal 45. Remotely locating the sensor apparatus 285 relative to the pedals 45 means that the pedal force indirectly acts on the sensor elements 320, 325 (e.g., through the crank arm 40 and the spider 57). As desired, additional sensors (e.g., an accelerometer, etc.) can be used in conjunction with the sensor apparatus 285 to provide more detailed information (e.g., power, etc.) regarding pressure being applied to the pedals 45. These additional sensors can be incorporated into the electronic module 410 or separately coupled to the bicycle 10.

Various features and advantages of the invention are set forth in the following claims.

1. A bicycle comprising:
a frame having a bottom bracket;
a crankset attached to the bottom bracket;
a pedal coupled to the crankset and operable to propel the bicycle in response to a force acting on the pedal;
a first bicycle component acted upon by the pedal in response to the force;
a second bicycle component coupled and responsive to the first component; and
sensor apparatus coupled to and sandwiched between the first component and the second component, the sensor apparatus including a sensor element positioned to sense a force transferred from the first component to the second component and indicative of the force acting on the pedal.

2. The bicycle of claim 1, wherein a substantial portion of the force acting on the pedal is transferred directly through the first bicycle component to the second bicycle component.

3. The bicycle of claim 1, wherein a substantial portion of the force transferred from the first bicycle component to the second bicycle component is transferred through the sensor apparatus.

4. The bicycle of claim 1, wherein the pedal includes a pedal spindle defining the first component and the crankset includes a crank arm defining the second component, wherein the pedal spindle has a shaft disposed in the crank arm, and wherein the sensor element is responsive to the force transferred from the pedal spindle to the crank arm.

5. The bicycle of claim 4, wherein the pedal spindle includes a flange proximate the crank arm, and wherein the sensor element is sandwiched between the flange and the crank arm.

6. The bicycle of claim 5, wherein the sensor apparatus further includes a housing positioned around a portion of the shaft and abutting the crank arm and the flange.

7. The bicycle of claim 6, wherein the sensor element is a first sensor element, the sensor apparatus further including a second sensor element, wherein the first sensor element and the second sensor element are enclosed by the housing, and wherein the second sensor element is spaced apart from the first sensor element and is movable relative to the first sensor element in response to the force applied to the pedal.

8. The bicycle of claim 7, further comprising a compressible medium disposed between the first sensor element and the second sensor element.

9. The bicycle of claim 7, wherein a portion of the housing is movable in response to the force applied to the pedal, and wherein movement of the portion of the housing moves the second sensor element relative to the first sensor element.

10. The bicycle of claim 7, further comprising a detector in communication with the first sensor element and the second sensor element to detect at least one of a change in distance and a change in volume between the first and second sensor elements, the change in distance or volume indicative of the force applied to the pedal.

11. The bicycle of claim 10, wherein the detector includes a first circuit board in electrical communication with the first sensor element and the second sensor element to determine the force applied to the pedal, and a second circuit board in electrical communication with the first circuit board and attached to the bicycle at a location remote from the first circuit board to determine a rotational position and velocity of the pedal.

12. The bicycle of claim 1, wherein the sensor element includes at least one of a strain gauge, a capacitive sensor, a piezoelectric sensor, and an optical sensor.

13. The bicycle of claim 1, wherein the crankset includes a spider having an insert coupled to the crank arm and defining the first bicycle component, and a central body defining the second bicycle component, wherein the insert is coupled to the central body, and wherein the sensor apparatus is positioned between the insert and the central body so that the sensor element is responsive to a force transferred from the insert to the central body to detect the force acting on the pedal.

14. The bicycle of claim 13, wherein the insert is at least partially nested within a recessed portion of the central body.

15. The bicycle of claim 14, wherein the sensor element is disposed in a cavity within the central body.

16. The bicycle of claim 13, wherein the insert is rotationally movable relative to the central body and has a spider engagement operatively coupled to the central body through the sensor apparatus to transfer the force from the insert to the central body.

17-22. (canceled)

23. A bicycle comprising:
a frame having a bottom bracket;
a crankset attached to the bottom bracket and including a crank arm and a spider operatively coupled to the crank arm;
a pedal coupled to the crank arm and operable to rotate the spider and propel the bicycle;
sensor apparatus disposed in the spider and positioned to sense a force acting on the pedal.

24. The bicycle of claim 23, wherein the spider defines a cavity and the sensor apparatus is disposed in the cavity.

25. The bicycle of claim 24, wherein the spider has an arm coupled to a sprocket of the bicycle, and wherein the cavity is radially aligned with the arm.

26. The bicycle of claim 24, wherein the sensor apparatus includes a sensor element, wherein the spider has an insert coupled to the crank arm and a central body, and wherein the insert is coupled to the central body and the sensor apparatus is positioned between the insert and the central body so that the sensor element is responsive to a force transferred from the insert to the central body.

27. The bicycle of claim 26, wherein the insert is rotationally movable relative to the central body.

28. The bicycle of claim 26, wherein the insert is at least partially nested within a recessed portion of the central body.

29. The bicycle of claim 26, wherein the insert has a spider engagement disposed in the cavity and engageable with the sensor apparatus in response to the force acting on the pedal.

30. A bicycle comprising:
a frame having a bottom bracket;
a crankset attached to the bottom bracket and including a crank arm and a spider operatively coupled to the crank arm;
a pedal coupled to the crank arm and operable to rotate the spider and propel the bicycle; and
sensor apparatus disposed in the spider and positioned to sense a force acting on the pedal,
wherein the sensor apparatus includes a first sensor element and a second sensor element spaced apart from the first sensor element such that a change in distance between the first and second sensor elements or a change in volume between the first and second sensor elements is indicative of the force applied to the pedal.

31. The bicycle of claim 30, wherein the second sensor element is movable relative to the first sensor element in response to pressure applied to the pedal.

32. The bicycle of claim 30, wherein the spider has a first portion and a second portion movable relative to the first portion, wherein the sensor apparatus includes a housing sandwiched between the first portion and the second portion, and wherein the housing supports the first sensor element and the second sensor element on opposing walls.

33. The bicycle of claim 32, wherein at least one of the opposing walls is movable in response to pressure applied to the pedal.

34. The bicycle of claim 30, wherein the first sensor element and the second sensor element cooperatively determine a radial force and a tangential force applied to the pedal.

35. The bicycle of claim 23, wherein the force transferred from the pedal to the spider is transferred through the sensor apparatus.
